(19) United States
(12) Patent Application Publication
(10) Pub. No.: US 2023/0276943 A1
(43) Pub. Date: Sep. 7, 2023

(54) BIOMETRIC SAFE CABINET ASSEMBLY

(71) Applicant: Kenneth Dillon, St Louis, MO (US)

(72) Inventor: Kenneth Dillon, St Louis, MO (US)

(21) Appl. No.: 17/683,708

(22) Filed: Mar. 1, 2022

(51) Int. Cl. A47B 81/00; E05G 1/04; E05B 47/00; E05B 65/00; A47B 79/00; G07C 9/00

(52) U.S. Cl. CPC A47B 81/005; E05G 1/04; E05B 47/0002; E05B 65/0075; A47B 79/00; G07C 9/00563; G07C 9/00912

(57) ABSTRACT

A biometric safe cabinet assembly for accessing the firearm safe from a bedside includes a cabinet. The cabinet is a nightstand and is positioned adjacent to a bedside. A scanner is attached to a side of the cabinet. The scanner is a biometric fingerprint reader that is in electric communication with a microprocessor. The microprocessor determines if the fingerprint reading matches the accepted fingerprint data. The microprocessor is in electric communication with a lock which is an electromagnet. The lock receives electric current from a power supply to produce a magnetic field that attracts the magnet of a door. The door is for a safe for a weapon is to be stored within. The magnetic field will diminish when the electric current is closed off by the microprocessor if the correct fingerprint is used. The safe can be accessed by the user without leaving the bedside.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to biometric firearm safes and more particularly pertains to a new biometric firearm safe for facilitation of accessing the firearm safe from a bedside.

### (2) Description of Related Art Including Information Disclosed Under 37 CFR 1.97 and 1.98

The prior art relates to biometric firearm safes. The prior art includes a variety of biometric firearm safes being positioned within a variation of furniture. Known prior art lacks a biometric firearm safe imbedded within a nightstand with an electromagnetic lock being configured for positioning adjacent to a bed whereby the user can access the safe without leaving the bed.

### BRIEF SUMMARY OF THE INVENTION

An embodiment of the disclosure meets the needs presented above by generally comprising a cabinet. The cabinet has a plurality of sides. The cabinet is configured for being positioned adjacent to a bed. The cabinet has a power source. The power source is configured for providing electric current to a variety of elements. Furthermore, the cabinet has a scanner. The scanner is a biometric fingerprint reader and is configured for reading a fingerprint of a user. The scanner is configured for being positioned proximate to a bedside of the user. A microprocessor is in electric communication with the scanner and with the power source. The microprocessor is configured for obtaining a correct fingerprint data. A safe defines a space for a weapon to be stored within. The safe has a door positioned on a second side of the plurality of sides. The door has a magnet that is a first portion of a lock mechanism. A lock is a second portion of the lock mechanism. The lock is an electromagnet. The lock is in electric communication with the microprocessor and with the power source. The lock is configured for receiving electric current from the power source whereby producing a magnetic field. The magnetic field is configured for retaining the magnet of the door in a fixed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric back view of a biometric safe cabinet assembly according to an embodiment of the disclosure.

FIG. 2 is a front view of an embodiment of the disclosure.

FIG. 3 is a side view of an embodiment of the disclosure.

FIG. 4 is a back view of an embodiment of the disclosure.

FIG. 5 is a detail in-use view of an embodiment of the disclosure.

### DETAILED DESCRIPTION OF THE INVENTION

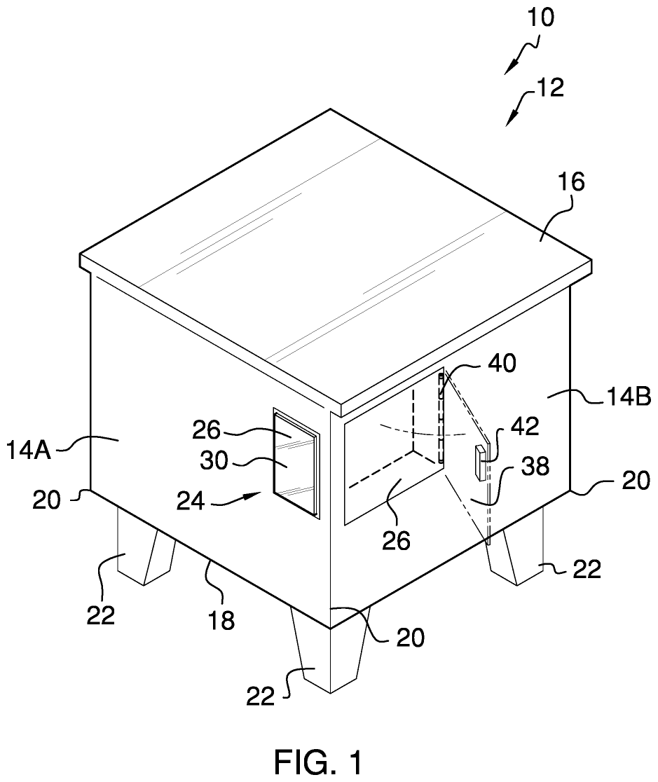

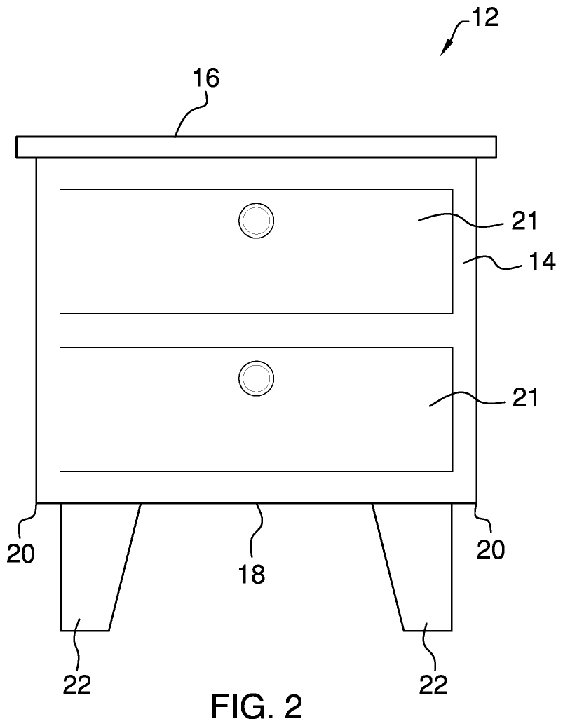

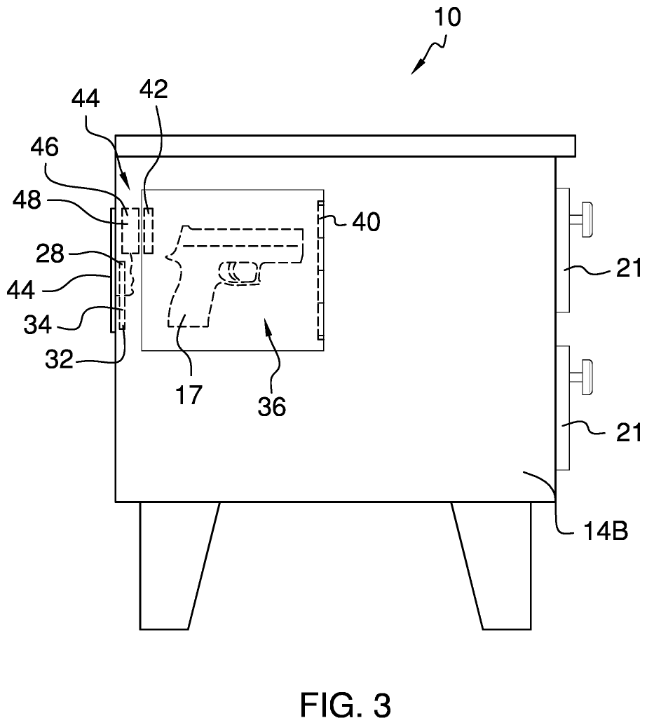

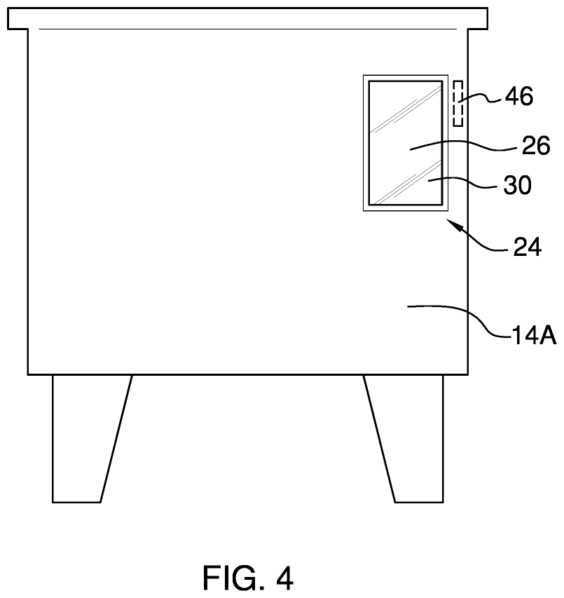

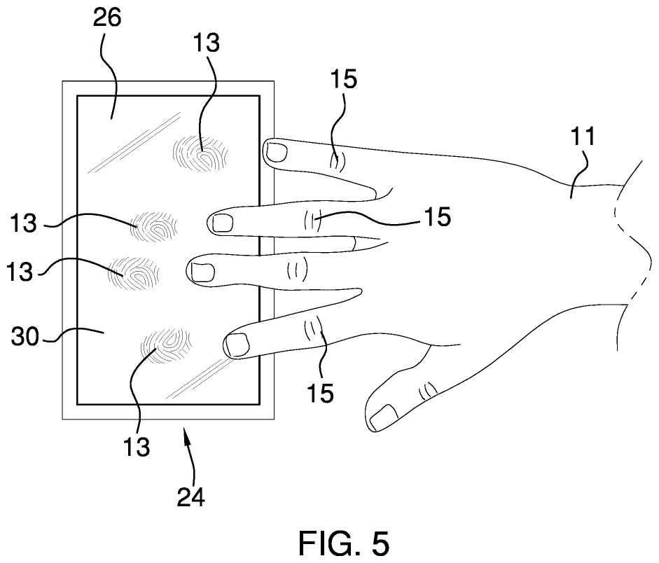

With reference now to the drawings, and in particular to FIGS. 1 through 5 thereof, a new biometric firearm safe embodying the principles and concepts of an embodiment of the disclosure and generally designated by the reference numeral 10 will be described.

As best illustrated in FIGS. 1 through 5, the biometric safe cabinet assembly 10 generally comprises a cabinet 12. The cabinet 12 has a cubic shape and has a plurality of sides 14. The cabinet 12 has a peripheral surface 16 and a bottom surface 18. The peripheral surface 16 is configured for placing a variety of items upon. The bottom surface 18 has a plurality of corners 20. Each footing 22 of a plurality of footing 22 is coupled proximate to a respective one of each corner 20 of the plurality of corners 20. The plurality of footing 22 provides support to the cabinet 12.

The cabinet 12 is configured for be positioned adjacent to a bedside whereby the user 11 can access the cabinet 12 without leaving the bed. A first side 14A of the plurality of sides 14 is positioned facing the bedside. A scanner 24 is coupled to the first side 14A. The scanner 24 is a biometric fingerprint reader 26. A power source 28 is in electric communication with the scanner 24 and provides electric current to the scanner 24. The power source 28 is a battery and is configured for providing electric current to a variety of elements within the cabinet 12. The cabinet 12 has a plurality of shelves 21. Each of the shelves 21 is configured for holding a variety of items such as clothing. The plurality of shelves 21 is configured for being positioned facing away from the bedside whereby disguising the biometric safe cabinet assembly 10 to appear as only a nightstand.

The scanner 24 is configured to reading a fingerprint 13 of a user 11. The scanner 24 has a surface 30 being configured for a plurality of fingers 15 of the user 11 to touch. A microprocessor 32 is in electric communication with the scanner 24 and obtains the fingerprint data from the scanner 24. The microprocessor 32 is a central processing unit 34 and is configured for determining if the fingerprint 13 data will be accepted or rejected. The scanner 24 is configured for being positioned proximate to the user whereby facilitating access to the biometric safe cabinet assembly 10 in a case of an emergency.

A safe 36 is positioned within an interior the cabinet 12. The safe 36 defines a space for a weapon 17, such as a handgun, to be stored within. The safe 36 has a door 38 positioned on a second side 14B of the plurality of sides 14. The second side 14B is adjacent to the first side 14A and is positioned perpendicular to the first side 14A. The door 38 has a hinge 40. The hinge 40 is coupled to the second side 14B and is configured for positioning the door 38 in an open or closed position relative to the safe 36.

The door 38 has a magnet 42. The magnet 42 is the first portion of a lock mechanism 44. The magnet 42 is complementary to a lock 46. The lock 46 is an electromagnet 48 and is in electric communication with the microprocessor 32 and with the power source 28. The lock 46 receives electric current to produce a magnetic field. The magnetic field attracts the magnet 42 and retains the door 38 in a fixed closed position. When the microprocessor 32 accepts a correct fingerprint 13 reading from the scanner 24, the microprocessor 32 closes off the electric current from the power source 28 to the lock 46 whereby diminishing the magnetic field. Once the magnetic field is enfeebled enough for the magnet 42 to detach from the lock 46, the door 38 of the safe 36 can be positioned open.

In use, a weapon 17 such as a firearm is stored within the safe 36 of the cabinet 12. The power source 28 provides electric current to the lock 46 whereby producing the magnetic field. Furthermore, the magnet 42 of the door is secured to the lock 46 and encloses the weapon 17 within the safe 36.

The user 11 remains at the bedside proximate to the cabinet 12. To open the safe 36, the plurality of fingers 15 of the user touches the surface 30 of the scanner 24. The scanner 24 reads the fingerprint 13 and sends the fingerprint 13 data to the microprocessor. The microprocessor determines if the fingerprint data matches to the encrypted fingerprints that disable the lock mechanism. If the fingerprint 13 does not match, then the electric current to the lock 46 remains running. Once the correct fingerprint 13 data is obtained, the microprocessor 32 closes off the electric current to the lock 46 to disengage the lock mechanism 44 of the safe 36. The user 11 can then access the weapon 17 without leaving the bedside.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. a biometric safe cabinet assembly comprising:
a cabinet, said cabinet having a plurality of sides, said cabinet being configured for being positioned adjacent to a bed;
a power source, said power source being configured for providing electric current to a variety of elements;
a scanner, said scanner being a biometric fingerprint reader, said scanner being configured for reading a fingerprint of a user, said scanner being configured for be positioned proximate to the bedside;
a microprocessor, said microprocessor being in electric communication with said scanner and with said power source, said microprocessor being configured for obtaining a correct fingerprint data;
a safe, said safe defining a space for a weapon to be stored within, said safe having a door, said door being positioned on a second side of said plurality of sides, said door having a magnet, said magnet being a first portion of a lock mechanism;
a lock, said lock being a second portion of said lock mechanism, said lock being an electromagnet, said lock being in electric communication with said microprocessor and with said power source, said lock being configured for receiving electric current from said power source whereby producing a magnetic field, said magnetic field being configured for retaining said magnet of said door in a fixed position whereby enclosing a weapon within said safe.

2. The biometric safe cabinet assembly of claim 1, further comprising said cabinet having a cubic shape.

3. The biometric safe cabinet assembly of claim 1, further comprising said cabinet having a plurality of shelves, each of said shelves being configured for holding a variety of items.

4. The biometric safe cabinet assembly of claim 1, further comprising said cabinet having a peripheral surface and a bottom surface, said peripheral surface being configured for positioning a variety of items upon.

5. The biometric safe cabinet assembly of claim 3, further comprising said bottom surface having a plurality of corners, each footing of a plurality of footing is coupled proximate to a respective one of each corner of said plurality of corners, said plurality of footing being configured for underpinning said cabinet, said cabinet being configured for being positioned adjacent to a bed.

6. The biometric safe cabinet assembly of claim 1, further comprising said power source being a battery.

7. The biometric safe cabinet assembly of claim 1, further comprising said scanner being in electric communication with said power source.

8. The biometric safe cabinet assembly of claim 1, further comprising said scanner being coupled to a first side of said plurality of sides.

9. The biometric safe cabinet assembly of claim 1, further comprising said microprocessor being a central processing unit.

10. The biometric safe cabinet assembly of claim 1, further comprising said safe being positioned within an interior of said cabinet.

11. The biometric safe cabinet assembly of claim 1, further comprising said door having a hinge, said hinge being coupled to said second side, said hinge being configured for positioning said door in an open position and a closed position.

12. The biometric safe cabinet assembly of claim 1, further comprising said lock being complementary to said magnet of said door.

13. The biometric safe cabinet assembly of claim 1, further comprising said microprocessor being configured for closing electric current to said lock when obtaining the correct fingerprint data whereby unlocking said magnet from said lock.

14. A biometric safe cabinet assembly comprising:
a cabinet, said cabinet having a cubic shape, said cabinet having a plurality of sides, said cabinet having a peripheral surface and a bottom surface, said cabinet having a plurality of shelves, each of said shelves being configured for holding a variety of items, said peripheral surface being configured for positioning a variety of items upon, said bottom surface having a plurality of corners, each footing of a plurality of footing is coupled proximate to a respective one of each corner of said plurality of corners, said plurality of footing being configured for underpinning said cabinet, said cabinet being configured for being positioned adjacent to a bed;
a power source, said power source being a battery, said power source being configured for providing electric current to a variety of elements;
a scanner, said scanner being a biometric fingerprint reader, said scanner being in electric communication with said power source, said scanner being configured for reading a fingerprint of a user, said scanner being coupled to a first side of said plurality of sides, said scanner being configured for be positioned proximate to the bedside;
a microprocessor, said microprocessor being a central processing unit, said microprocessor being in electric communication with said scanner and with said power source, said microprocessor being configured for obtaining a correct fingerprint data;
a safe, said safe being positioned within an interior of said cabinet, said safe defining a space for a weapon to be stored within, said safe having a door, said door being positioned on a second side of said plurality of sides, said door having a hinge, said hinge being coupled to said second side, said hinge being configured for positioning said door in an open position and a closed position, said door having a magnet, said magnet being a first portion of a lock mechanism;
a lock, said lock being a second portion of said lock mechanism, said lock being an electromagnet, said lock being in electric communication with said microprocessor and with said power source, said lock being configured for receiving electric current from said power source whereby producing a magnetic field, said magnetic field being configured for retaining said magnet of said door in a fixed position whereby enclosing a weapon within said safe, said lock being complementary to said magnet of said door, said microprocessor being configured for closing electric current to said lock when obtaining the correct fingerprint data whereby unlocking said magnet from said lock.
